(19) United States
(12) Patent Application Publication
(10) Pub. No.: US 2023/0207867 A1
(43) Pub. Date: Jun. 29, 2023

(54) METHOD OF PREDICTING LITHIUM ION CONDUCTIVITY OF SOLID ELECTROLYTE

(71) Applicants: Hyundai Motor Company, Seoul (KR); Kia Corporation, Seoul (KR); Industry-University Cooperation Foundation Hanyang University ERICA Campus, Ansan (KR)

(72) Inventors: Ju Yeong Seong, Seongnam (KR); In Woo Song, Gwacheon (KR); Sang Heon Lee, Yongin (KR); Sung Woo Noh, Seoul (KR); Je Sik Park, Seoul (KR); Jeong Hyun Seo, Dajeon (KR); Yong Jun Jang, Seongnam (KR); A Reum Ha, Ulsan (KR); Sang Uck Lee, Bucheon (KR); Byeong Sun Jun, Suwon (KR)

(21) Appl. No.: 17/964,424

(22) Filed: Oct. 12, 2022

(30) Foreign Application Priority Data
Dec. 24, 2021 (KR) 10-2021-0187703

(51) Int. Cl. H01M 10/0562

(52) U.S. Cl. CPC H01M 10/0562; H01M 2300/008

(57) ABSTRACT

Disclosed is a method of predicting the lithium ion conductivity of a solid electrolyte having a specific composition.

### CROSS REFERENCE TO RELATED APPLICATION

The present application claims priority to Korean Patent Application No. 10-2021-0187703, filed Dec. 24, 2021, the entire contents of which is incorporated herein for all purposes by this reference.

### TECHNICAL FIELD

The present invention relates to a method of predicting the lithium ion conductivity of a solid electrolyte having a specific composition.

### BACKGROUND OF THE INVENTION

Rechargeable secondary batteries have been used not only in small electronic devices such as mobile phones and laptops but also in large vehicles such as hybrid vehicles and electric vehicles. Accordingly, there is a need to develop a secondary battery having higher stability and energy density.

Existing secondary batteries have been made of cells based on organic solvents (i.e., organic liquid electrolytes), so there are limitations in improving stability and energy density of the existing secondary batteries.

All-solid-state batteries using solid electrolytes have recently been in the spotlight because these batteries are based on a technology that do not use organic solvents and thus the cells thereof can be manufactured in a safer and simpler form.

In the all-solid batteries, a solid electrolyte is required for movement of lithium ions in an electrode layer and a solid electrolyte layer. Therefore, to improve the capacity and efficiency of all-solid-state batteries, it is essential to develop a solid electrolyte having high lithium ion conductivity.

However, it is very time-consuming and exhausting to actually construct many solid electrolytes having different compositions and to measure their lithium ion conductivity to obtain a solid electrolyte having high lithium ion conductivity. Accordingly, attempts have been made to calculate and predict the lithium ion conductivity of a solid electrolyte.

However, the theoretical lithium ion conductivity obtained using computational science and the lithium ion conductivity measured experimentally are different due to various natural phenomena. In particular, computational science assumes that the solid electrolyte is an ideal perfect crystal, but the actually manufactured solid electrolyte has crystallinity that varies each time depending on the manufacturing method and conditions. Therefore, there is a big difference between the ideal conductivity and the actual conductivity.

### SUMMARY OF THE INVENTION

In preferred aspects, provided is a method of predicting the lithium ion conductivity of a solid electrolyte with high accuracy.

However, the objectives of the present invention are not limited the one described above. The objectives of the present invention will become more apparent from the following description and will be realized with components recited in the claims and combinations of the components.

In an aspect, a method of predicting lithium ion conductivity of a solid electrolyte includes the steps of: calculating the lithium ion conductivity of a solid electrolyte to obtain a calculated value σ_{calc}; and obtaining a predicted value σₚᵣₑ of the lithium ion conductivity of the solid electrolyte according to Equation 1 using the calculated value (σ_{calc}).

σₚᵣₑ=σ_{calc}·χ_{c}^{7.14} [Equation 1]

In Equation 1, χ_{c} represents the crystallinity of a solid electrolyte.

The solid electrolyte may be represented by Chemical Formula 1 below.

Li₆₋ₐPS₅₋ₐXₐ [Chemical Formula 1]

Here, 1≤a≤2, X is a halogen such as chlorine (Cl), bromine (Br), or iodine (I).

The crystallinity may range from about 0.7 to 0.8.

Equation 1 may be obtained by performing the steps of: calculating a lithium ion conductivity value of each solid electrolyte to obtain the calculated value σ_{calc}; synthesizing the solid electrolytes to obtain an actual lithium ion conductivity value σₑₓₚ of each of the synthesized solid electrolytes; obtaining crystallinity y of each of the synthesized solid electrolytes; and performing regression analysis on the crystallinity values y and the actual lithium ion conductivity values σₑₓₚ/the calculated values σ_{calc}.

In another aspect, provided is a solid electrolyte including a compound of Chemical Formula 1,

Li₆₋ₐPS₅₋ₐXₐ [Chemical Formula 1]

where 1≤a≤2, and X is a halogen selected from as chlorine (Cl), bromine (Br), and iodine (I).

In particular, a crystallinity of the solid electrolyte satisfies the Equation 1:

σₚᵣₑ=σ_{calc}·χ_{c}^{7.14} [Equation 1]

wherein σ_{calc} is a calculated value by calculating a lithium ion conductivity of a solid electrolyte;

χ_{c}^{7.14} is a crystallinity of the solid electrolyte; and

σₚᵣₑ is a predicted value of the lithium ion conductivity of the solid electrolyte from the calculated value σ_{calc} using Equation 1.

Also, provided is an all-solid-state battery including the solid electrolyte described herein.

A term “all-solid state battery” as used herein refers to a rechargeable secondary battery that includes an electrolyte in a solid state, e.g., gel or polymer (cured), which may include an ionomer and other electrolytic components for transferring ions between the electrodes of the battery.

Other aspects of the invention are disclosed infra.

According to various exemplary embodiments of the present invention, the lithium ion conductivity of a solid electrolyte can be predicted with high accuracy.

However, the advantages of the present invention are not limited thereto. It should be understood that the advantages of the present invention include all effects that can be inferred from the description given below.

### BRIEF DESCRIPTION OF THE DRAWINGS

FIG. 1 is a view illustrating a process of performing regression analysis according to one embodiment of the present invention.

### DETAILED DESCRIPTION

Above objectives, other objectives, features, and advantages of the present invention will be readily understood from the following preferred embodiments associated with the accompanying drawings.

However, the present invention is not limited to the embodiments described herein and may be embodied in other forms. The embodiments described herein are provided so that the disclosure can be made thorough and complete and that the spirit of the present invention can be fully conveyed to those skilled in the art.

Throughout the drawings, like elements are denoted by like reference numerals. In the accompanying drawings, the dimensions of the structures are larger than actual sizes for clarity of the present invention. Terms used in the specification, “first”, “second”, etc., may be used to describe various components, but the components are not to be construed as being limited to the terms. These terms are used only for the purpose of distinguishing a component from another component. For example, a first component may be referred as a second component, and the second component may be also referred to as the first component. As used herein, the singular forms “a”, “an”, and “the” are intended to include the plural forms as well unless the context clearly indicates otherwise.

It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

Among other things, provided is a method of predicting lithium ion conductivity with high accuracy without actually manufacturing a solid electrolyte. In particular, the lithium ion conductivity of the solid electrolyte, which is obtained through computational science, can be corrected based on the crystallinity.

In an aspect, provided is a method of predicting lithium ion conductivity of a solid electrolyte. The method includes the steps of calculating the lithium ion conductivity of a solid electrolyte to obtain a calculated value σ_{calc} and obtaining a predicted value σₚᵣₑ of the lithium ion conductivity of the solid electrolyte according to Equation 1 using the calculated value (σ_{calc}),

σₚᵣₑ=σ_{calc}·χ_{c}^{7.14} [Equation 1]

In Equation 1, χ_{c} represents the crystallinity of the solid electrolyte.

The solid electrolyte may suitably include a sulfide-based solid electrolyte, preferably a sulfide-based solid electrolyte having an argyrodite-type crystal structure represented by Chemical Formula 1.

Li₆₋ₐPS₅₋ₐXₐ [Chemical Formula 1]

Here, 1≤a≤2, and X is a halogen such as chlorine (Cl), bromine (Br), or iodine (I).

The method of calculating the lithium ion conductivity of a solid electrolyte in computational science may include an one-principle molecular dynamics method (also called Ab initio molecular dynamics (AIMID)) that combines density functional theory (DFT) and molecular dynamics theory (MD).

For example, as an initial structure for AIMD simulation according to the temperature of the solid electrolyte crystal structure to be investigated first, an energetically optimized structure at 0 K may be obtained by DFT simulation. Then, AIMD simulations can be performed on the optimized crystal structure at several high temperatures (for example, about 600K, 800K, 1000K, and 1200K).

Means square displacement (MSD) can be extracted by analyzing the trajectory obtained from the AIMD simulation result. This is to calculate preliminary ionic conductivity using the MSD extraction value and the Eistein diffusion equation. Particularly, the trajectory of the AIMD simulation can be analyzed by extracting the positions of ions per unit time of the simulation, the MSD can be calculated by Equation 2 below, and the diffusivity (D) can be calculated by Equation 3.

$$MSD = 〈 {[ r ( t ) ]}^{2} 〉 = \frac{1}{N} {\sum }_{i} 〈 {[ {r}_{i} ( t + {t}_{0} ) ]}^{2} - {[ {r}_{i} ( {t}_{0} ) ]}^{2} 〉 \qquad [ Equation 2 ]$$

$${D}_{T} = \frac{1}{2 dt} MSD \qquad [ Equation 3 ]$$

Next, the preliminary ion conductivity can be inferred from the diffusivity at a temperature of about 300 K by Arrhenius fitting. In particular, since the ion diffusivity in a solid without a phase transition satisfies the Arrhenius correlation (denoted by Equation 4), it is possible to infer the diffusivity at 300 K by Arrhenius fitting the diffusivity obtained by simulation at a high temperature (typically in the range of 600K to 1200K). By putting the diffusivity at 300 K obtained through the fitting into the Einstein diffusion equation (denoted by Equation 5), the ion conductivity at 300 K can be calculated. In Equation 5, P is the density of diffusion ions in a unit cell Z, is the charge of the diffusion ions, F is the Faraday constant, and R is the gas constant.

$$D = {D}_{0} exp ( - \frac{{E}_{a}}{kT} ) \qquad [ Equation 4 ]$$

$${σ}_{300 K} = \frac{ρ {z}^{2} {P}^{2}}{RT} {D}_{300 K} \qquad [ Equation 5 ]$$

The ion conductivity σ_{300K} at room temperature, obtained through the above process, can be defined as the final calculated value σ_{calc}.

Since the calculated value ac e is obtained on the premise that the solid electrolyte is an ideal perfect crystal, the calculated value may show a large difference from the actual lithium ion conductivity value of the solid electrolyte. The lithium ion conductivity of the solid electrolyte may be more accurately predicted by applying an offset value according to the crystallinity y to the calculated value ca using the equation.

The crystallinity χ_{c} represents the ratio of the crystalline portion included in the solid electrolyte. When the crystallinity λ_{c} is 1, it means that 100% of the solid electrolyte is crystalline, whereas when it is 0, it means that 100% of the solid electrolyte is amorphous. The closer the crystallinity χ_{c} to 1, the greater the ratio of the crystalline portion in the solid electrolyte.

The sulfide-based solid electrolyte having an azirodite-type crystal structure showing good lithium ion conductivity may have a crystallinity χ_{c} of about 0.7 to 0.8.

The equation may be obtained by performing the steps of: calculating a lithium ion conductivity value of each solid electrolyte having a composition within a specific range to obtain a calculated value σ_{calc}; synthesizing the solid electrolytes to obtain an actual lithium ion conductivity value σₑₓₚ of each of the synthesized solid electrolytes; obtaining crystallinity y of each of the synthesized solid electrolytes; and performing regression analysis on the crystallinity values χ_{c} and the actual lithium ion conductivity values σₑₓₚ/the calculated values σ_{calc}.

A method of obtaining the above equation will be described below with reference to specific examples.

First, the lithium ion conductivity of each of the sulfide-based solid electrolytes having the respective compositions shown in Table 1 below was calculated by the above-described method to obtain calculated values σ_{calc}.

Next, after actually synthesizing the sulfide-based solid electrolytes according to the respective compositions, the actual lithium ion conductivity σₑₓₚ of each of the synthesized sulfide-based solid electrolytes was measured. Since differences in the crystallinity of the solid electrolyte occurred depending on the synthesis method, it may be preferable to synthesize the solid electrolytes using various methods.

In this example, the sulfide-based solid electrolytes were synthesized as follows.

Synthesis Method 1

Starting materials including Li₂S, P₂S₅ and LiX were weighed and prepared according to the determined compositions. To amorphize each of the starting materials, each of the starting materials was milled for about 9 hours at about 700 RPM so that a force of about 49 gravitational acceleration (G-force) was applied to the starting material. For each composition, the resultant was heat-treated at a temperature of about 550° C. for about 20 minutes for crystallization, thereby obtaining a crystallized sulfide-based solid electrolyte.

Synthesis Method 2

Crystallized sulfide-based solid electrolytes were obtained in the same manner as in Synthesis Method 1, except that milling conditions were changed such that a force of about 37 gravitational acceleration was applied to the starting materials.

Next, the actual lithium ion conductivity σₑₓₚ and crystallinity χ_{c} of each synthesized sulfide-based solid electrolyte were measured.

Methods for measuring the lithium ion conductivity σₑₓₚ and the crystallinity χ_{c} are not particularly limited. Such physical properties may be measured by any method widely used in the technical field to which the present invention pertains.

TABLE 1

| | Calculated | Synthesis | | Synthesis | |
|---|---|---|---|---|---|
| | (σ_{calc}) | Method 1 | | Method 2 | |
| Composition | value | σₑₓₚ | χc | σₑₓₚ | χc |
| Li₆PS₅Cl | 18.79 | 3.10 | 0.77 | 2.30 | 0.69 |
| Li_{5.75}PS_{4.75}Cl_{1.25} | 27.32 | 7.00 | 0.80 | 5.10 | 0.74 |
| Li_{5.5}PS_{4.5}Cl_{1.5} | 52.11 | 10.20 | 0.83 | 5.10 | 0.76 |
| Li_{5.25}PS_{4.25}Cl_{1.75} | 142.89 | 2.00 | 0.71 | 0.90 | 0.58 |

In Table 1, the unit of the lithium ion conductivity is mS/cm.

The above-described equation may be obtained on the basis of the results shown in Table 1 above.

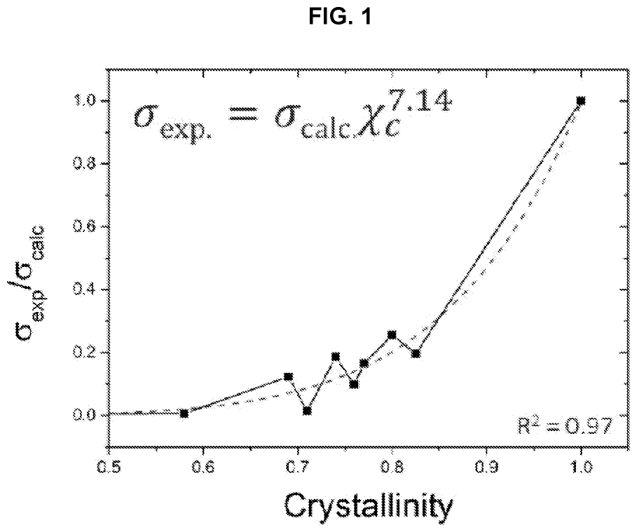

As shown in FIG. 1, the measured lithium ion conductivity σₑₓₚ/calculated value σ_{calc} according to each crystallinity y was plotted as a coordinate, and the regression equation was obtained by performing regression analysis on the coordinates.

σₑₓₚ=σ_{calc}·χ_{c}^{7.14}

The regression equation compensates for the difference between the calculated value σ_{calc} and the measured lithium ion conductivity σₑₓₚ depending on the crystallinity χ_{c}. By setting the measured lithium ion conductivity σₑₓₚ as a predicted value arm, the above equation can be obtained. Using the above equation a predicted value σₚᵣₑ, very close to the actual lithium ion conductivity can be obtained from the calculated value σ_{calc} without actually synthesizing many sulfide-based solid electrolytes.

Tables 2 to 4 below show predicted values σₚᵣₑ each of which is obtained from the measured lithium ion conductivity σ_{calc} of a sulfide-based solid electrolyte by using the equation. At this time, the degree of crystallinity χ_{c} in the equation was set to 0.7 and 0.8. The unit of each value is mS/cm.

TABLE 2

| Composition | σ_{calc} (100 crystalline) | σₚᵣₑ (χc = 0.8) | σₚᵣₑ (χc = 0.7) |
|---|---|---|---|
| Li₆PS₅Cl | 18.79 | 3.82 | 1.47 |
| Li_{5.75}PS_{4.75}Cl_{1.25} | 27.32 | 5.55 | 2.14 |
| Li_{5.5}PS_{4.5}Cl_{1.5} | 52.11 | 10.59 | 4.08 |
| Li_{5.25}PS_{4.25}Cl_{1.75} | 142.89 | 29.04 | 11.19 |
| Li₅PS₄Cl₂ | 78.3 | 15.92 | 6.13 |

TABLE 3

| Composition | σ_{calc} (100 crystalline) | σₚᵣₑ (χc = 0.8) | σₚᵣₑ (χc = 0.7) |
|---|---|---|---|
| Li₆PS₅Br | 15.36 | 3.12 | 1.20 |
| Li_{5.75}PS_{4.75}Br_{1.25} | 14.22 | 2.89 | 1.11 |
| Li_{5.5}PS_{4.5}Br_{1.5} | 32.23 | 6.55 | 2.52 |
| Li_{5.25}PS_{4.25}Br_{1.75} | 61.1 | 12.42 | 4.79 |
| Li₅PS₄Br₂ | 117.3 | 23.84 | 9.19 |

TABLE 4

| | σ_{calc} | | |
|---|---|---|---|
| | (100 | | |
| Composition | crystalline) | σₚᵣₑ (χc = 0.8) | σₚᵣₑ (χc = 0.7) |
| Li₆PS₅I | 4.14 | 0.84 | 0.32 |
| Li_{5.75}PS_{4.75}I_{1.25} | 7.76 | 1.58 | 0.61 |
| Li_{5.5}PS_{4.5}I_{1.5} | 13.51 | 2.75 | 1.06 |
| Li_{5.25}PS_{4.25}I_{1.75} | 32.79 | 6.67 | 2.57 |
| Li₅PS₄I₂ | 64.5 | 13.11 | 5.05 |

As shown in Tables 2 to 4, the lithium ion conductivity value of a sulfide-based solid electrolyte having a specific composition were predicted as a value within a specific range.

Table 5 below shows the actual lithium ion conductivity of the sulfide-based solid electrolyte reported in Angew. Chem. Int. Ed. described on 2019, vol. 58, 8681-8686.

TABLE 5

| Composition | Lithium ion conductivity [mS/cm] |
|---|---|
| Li₆PS₅Cl | 2.5 |
| Li_{5.75}PS_{4.75}Cl_{1.25} | 4.2 |
| Li_{5.625}PS_{4.625}Cl_{1.375} | 5.6 |
| Li_{5.5}PS_{4.5}Cl_{1.5} | 9.4 |
| Li_{5.5}PS_{4.5}Cl_{1.5}, (Sintered) | 12.0 |
| Li_{5.45}PS_{4.45}Cl_{1.55} | 5.9 |
| Li_{5.4}PS_{4.4}Cl_{1.6} | 3.3 |

Comparing the results of Table 2 and Table 5, the value of the actual lithium ion conductivity fell within the range of the predicted lithium ion conductivity. For example, the lithium ion conductivity of Li₆PS₅Cl predicted by the method according to an exemplary embodiment of the present invention was 1.47 to 3.82 mS/cm, and the known actual lithium ion conductivity of Li₆PS₅Cl was 2.5 mS/cm which falls within the above range.

Through the description above, the accurate predicted value σₚᵣₑ can be obtained by correcting the calculated value σ_{calc} using the above equation according to the present invention.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of a predicting lithium ion conductivity value of a solid electrolyte, comprising:
obtaining a calculated value σ_{calc} by calculating a lithium ion conductivity of a solid electrolyte; and
obtaining a predicted value σₚᵣₑ of the lithium ion conductivity of the solid electrolyte from the calculated value σ_{calc} using Equation 1:
σₚᵣₑ=σ_{calc}·χ_{c}^{7.14} [Equation 1]
in Equation 1, χ_{c} represents the crystallinity of the solid electrolyte.

2. The method according to claim 1, wherein the solid electrolyte is represented by Chemical Formula 1,
Li₆₋ₐPS₅₋ₐXₐ [Chemical Formula 1]
where 1≤a≤2, and X is a halogen selected from as chlorine (Cl), bromine (Br), and iodine (I).

3. The method according to claim 1, wherein the crystallinity is in a range of about 0.7 to 0.8.

4. The method according to claim 1, wherein Equation 1 is obtained by the steps of:
obtaining the calculated value σ_{calc} of the lithium ion conductivity of each of a plurality of solid electrolytes;
obtaining an actual lithium ion conductivity σₑₓₚ of each of the plurality of solid electrolytes after synthesizing the solid electrolytes;
obtaining a degree of crystallinity χ_{c} of each of the synthesized solid electrolytes; and
performing regression analysis on the crystallinities χₑ, the actual lithium ion conductivities σₑₓₚ, and the calculated values σ_{calc}.

5. A solid electrolyte comprising a compound of Chemical Formula 1,
Li₆₋ₐPS₅₋ₐχₐ [Chemical Formula 1]
where 1≤a≤2, and X is a halogen selected from as chlorine (Cl), bromine (Br), and iodine (I),
wherein
a crystallinity of the solid electrolyte satisfies the Equation 1:
σₚᵣₑ=σ_{calc}·χ_{c}^{7.14} [Equation 1]
wherein σ_{calc} is a calculated value by calculating a lithium ion conductivity of a solid electrolyte;
χ_{c}^{7.14} is the crystallinity of the solid electrolyte; and
σₚᵣₑ is a predicted value of the lithium ion conductivity of the solid electrolyte from the calculated value σ_{calc} using Equation 1.

6. An all-solid-state battery comprising a solid electrolyte of claim 5.
